(19) United States
(12) Patent Application Publication
(10) Pub. No.: US 2006/0068806 A1
(43) Pub. Date: Mar. 30, 2006

(54) Method and apparatus of selectively blocking harmful P2P traffic in network

(76) Inventors: Taek Yong Nam, Daejeon-city (KR); Ho Gyun Lee, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/014,556

(22) Filed: Dec. 15, 2004

(30) Foreign Application Priority Data
Sep. 30, 2004 (KR) 10-2004-0077730

(51) Int. Cl. H04Q 7/20

(52) U.S. Cl. 455/452.2; 455/450

(57) ABSTRACT

A method of selectively blocking harmful P2P traffic on a network is provided. The method includes: (a) determining whether data transmitted to and from external terminals through the network is P2P traffic; (b) when it is determined that the data is P2P traffic, determining whether the transmitted and received P2P traffic is harmful; (c) when it is determined that the traffic is harmful, blocking the P2P traffic transmitted to and from the external terminals. Therefore, to block harmful P2P traffic distributed in the network, whether or not texts, images, and videos are harmful can be determined on a personal computer. Thus, the traffic can be checked and blocked in real time.

### BACKGROUND OF THE INVENTION

This application claims the priority of Korean Patent Application No. 2004-77730, filed on Sep. 30, 2004, in the Korean Intellectual Property Office, the disclosure of which is incorporated herein in its entirety by reference.

1. Field of the Invention

The present invention relates to a method and apparatus of selectively blocking harmful P2P traffic on a network, and more specifically, to a method and apparatus capable of selectively blocking harmful information based on contents in the P2P network where harmful information (e.g., pornography) and illegal software are distributed.

2. Description of Related Art

Conventionally, a main interest in a computer security has been focused on protection of a computer system itself, i.e., protection against viruses or system attacks such as denial of service attacks (DoS attack), or communication encryption used for cash transfer service at a bank. However, with regard to influence given by exchanging contents to human beings, a research on automatic detection and blocking of obviously harmful information is now required. Some large companies have already constructed a monitoring system in their own intranet to prepare outflow of essential company secrets. The construction of monitoring and protection system may lead to invasion of private information so that there may occur an extremely subtle legal problem. Therefore, a method of developing a system detecting and preventing under the approval of user obviously harmful information or illegal information is required.

In general, a harmful traffic selective blocking technology has been commercialized as a harmful site blocking products. The harmful site blocking products are largely classified into a pre-blocking method and a post-blocking method.

The pre-blocking method is a method of constructing a URL database in advance, searching the database when a user inputs a URL into a browser, and blocking a connection when the URL is a harmful one. The pre-blocking method has a merit in that it is highly accurate when used in constructing the DB, due to an automatic classification technology and a human checking process. However, it has a drawback in that the DB cannot have all URLs and that, for the URL having constantly changing contents, a wrong determination may be stored in the DB.

The post-blocking method is a method of checking in real time whether texts or images in the traffic are harmful to block the harmful sites. The post-blocking method has drawbacks in that the accuracy is lower than that for the pre-blocking method since the URL harmfulness needs checking in real time, and that the user may feel the traffic is even slower than as it is since the checking is performed over the traffic in transmission.

The essential of the harmful information blocking technology lies in improvement of accuracy of the automatic classification technology. The automatic contents classification can be classified into a text classification and an image classification. A lot of research has already been made on the text classification in the fields of information classification and blocking. Here, the text classification shows a significant performance on the common text contents. In particular, for a True/False problem picking up texts in a specific field such as harmful information blocking, the text classification shows even greater performance. However, for a P2P network, the only thing available in the text classification is just a file name, which indicates there is too little material to perform the text classification.

Further, a lot of research has recently been made on a method of analyzing image contents to determine whether images are harmful. The research has largely been attempted in two approaches. One approach is to use features used to retrieve images in the field of content based image retrieval (CBIR) to determine whether the images are pornographies. The other approach is to extract a skin area from an image, and extract a high-level featuring vector capable of representing a harmful image in the next skin area to determine whether the image is harmful. However, the approach in terms of the CBIR has a problem in that a lot of time is spent in determining whether the image is harmful. In addition, the approach in terms of extracting the high-level featuring vector from the skin area has a problem in that accuracy is low since the typically used high-level features mainly is based on skin color information.

### SUMMARY OF THE INVENTION

The present invention provides a method and apparatus of selectively blocking harmful P2P traffic on a network, capable of selectively blocking just harmful information without a need to block the whole P2P network by using the three types of information classification algorithm, i.e., a text classification, an video classification, and an image classification.

The present invention also provides an optimal algorithm used for a text contents classification on the P2P network.

The present invention also provides a method capable of efficiently blocking harmful images on the P2P network by exactly determining whether the image is harmful, using shape information of the harmful images in transmission on the P2P network.

The present invention also provides a mechanism interrupting a portion of an video file to restore this in a key frame unit and determining whether the key frame images are harmful, based on the fact that most pornography is distributed in videos on the P2P network.

According to an aspect of the present invention, there is provided a method of selectively blocking harmful P2P traffic on a network, the method comprising: (a) determining whether data transmitted to and from external terminals through the network is P2P traffic; (b) when it is determined that the data is P2P traffic, determining whether the transmitted and received P2P traffic is harmful; (c) when it is determined that the traffic is harmful, blocking the P2P traffic transmitted to and from the external terminals.

According to another aspect of the present invention, there is provided an apparatus of selectively blocking harmful P2P traffic on a network comprising: a transceiver unit transmitting and receiving data with external terminals; a P2P traffic detection unit determining whether data transmitted to and from the external terminals are P2P data; a harmful P2P traffic determination unit determining whether the data transmitted to and from the external terminals are harmful; and a control unit sending data transmitted and received through the transceiver unit to the harmful P2P traffic determination unit when a P2P traffic detection signal is input from the P2P traffic detection unit, and controlling the transceiver to block transmitting and receiving data with the external terminals when a harmful P2P traffic determination signal is input from the harmful P2P traffic determination unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a flow chart for explaining a process of selectively blocking harmful P2P traffic by using text classification algorithm according to an embodiment of the present invention;

FIG. 2 is a flow chart for explaining a process of selectively blocking harmful P2P traffic by using text classification algorithm according to another embodiment of the present invention;

FIG. 3 is a flow chart for explaining a process of selectively blocking harmful P2P traffic by using video classification algorithm according to an embodiment of the present invention;

FIG. 4 is a flow chart for explaining a process of selectively blocking harmful P2P traffic by using image classification algorithm according to another embodiment of the present invention;

FIG. 5 is a detailed flow chart for explaining operation S250 of FIG. 2;

FIG. 6 is a detailed flow chart for explaining a process of detection the harmful P2P traffic of FIGS. 1 to 4;

FIG. 7 is a block diagram showing an apparatus of selectively blocking harmful P2P traffic on a network according to an embodiment of the present invention;

FIG. 8 is an example of the detailed block diagram showing a text classification module 760 of FIG. 7;

FIG. 9 is another example of the detailed block diagram showing a text classification module 760 of FIG. 7;

FIG. 10 is a detailed block diagram showing an video classification module 770 of FIG. 7; and

FIG. 11 is a detailed block diagram showing an image classification module 780 of FIG. 7.

### DETAILED DESCRIPTION OF THE INVENTION

Now, exemplary embodiments of the present invention will be described with reference to the attached drawings.

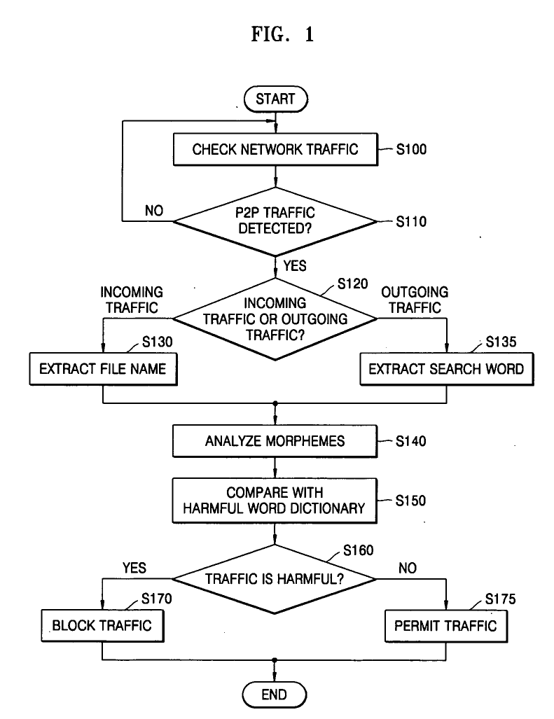

FIG. 1 is a flow chart for explaining a process of selectively blocking harmful P2P traffic by using text classification algorithm according to an embodiment of the present invention.

Network traffic transmitted to and from external devices is monitored in a P2P traffic selective blocking system on a network (S100).

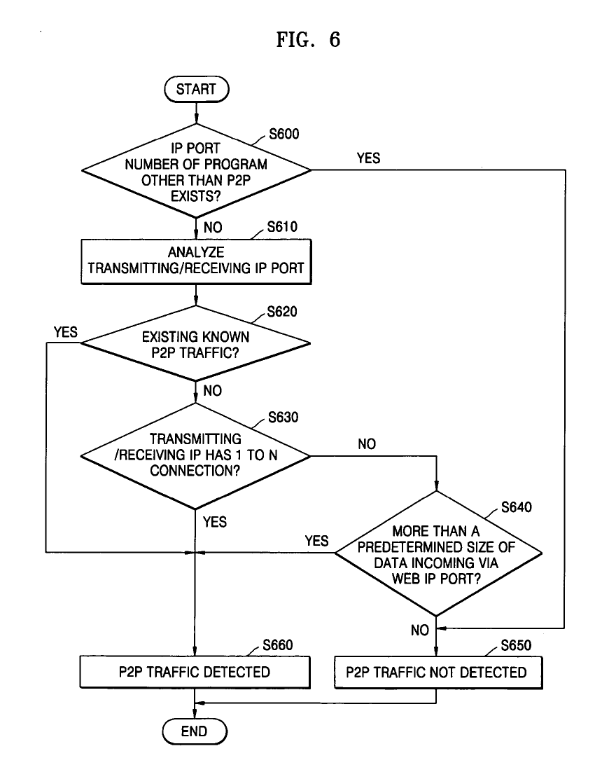

Next, it is determined whether the P2P traffic is detected (S110). This determination will be described later in more detail with reference to FIG. 6. When it is determined that the P2P traffic is not detected, the process returns to operation S100. Otherwise, i.e., when it is determined that the P2P traffic is detected, the process proceeds to operation S120.

Next, it is determined whether the P2P traffic is incoming or outgoing (S120). This determination is based on whether a predetermined data is incoming from the external devices through a receiving unit or outgoing to the external device through a transmitting unit. When it is determined that the P2P traffic is incoming, the process proceeds to operation S130. Otherwise, when it is determined that the P2P traffic is outgoing, the process proceeds to operation S135.

In operation S130, a file name of the incoming P2P traffic is extracted.

In operation S135, a search word of the outgoing P2P traffic is extracted.

Next, afteroperations S130 and S135, morphological analysis is made on the extracted file name or search word (S140). During the operation S140, parts of speech such as nouns, verbs, and adjectives are extracted.

Next, the extracted parts of speech are compared with harmful words in a harmful-word dictionary (S150). Here, a harmful-word dictionary is not a typical dictionary used for a harmful text classification but a dictionary having specific weights based on analysis of features of frequently used terms on the P2P network.

Next, it is determined whether the P2P traffic in transmission is harmful (S160). The above determination is based on whether the traffic has a harmful word contained in the harmful-word dictionary. When it is determined that the P2P traffic is not harmful, the P2P traffic is passed (S175). However, when it is determined that the P2P traffic is harmful, the P2P traffic is blocked (S170).

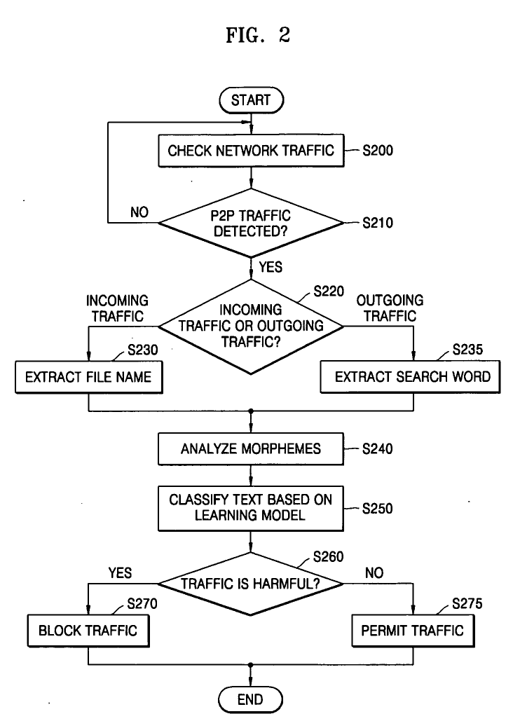

FIG. 2 is a flow chart for explaining a process of selectively blocking harmful P2P traffic by using text classification algorithm according to another embodiment of the present invention.

Network traffic transmitted to and from external devices is monitored in a P2P traffic selective blocking system on a network (S200).

Next, it is determined whether the P2P traffic is detected (S210). This determination will be described later in more detail with reference to FIG. 6. When it is determined that the P2P traffic is not detected, the process returns to operation S200. Otherwise, i.e., when it is determined that the P2P traffic is detected, the process proceeds to operation S220.

Next, it is determined whether the P2P traffic is incoming or outgoing (S220). This determination is based on whether a predetermined data is incoming from the external devices through a receiving unit or outgoing to the external device through a transmitting unit. When it is determined that the P2P traffic is incoming, the process proceeds to operation S230. Otherwise, when it is determined that the P2P traffic is outgoing, the process proceeds to operation S235.

In operation S230, a file name of the incoming P2P traffic is extracted.

In operation S235, a search word of the outgoing P2P traffic is extracted.

Next, after operations S230 and S235, morphological analysis is made on the extracted file name or search word (S240). During the operation S240, parts of speech such as nouns, verbs, and adjectives are extracted.

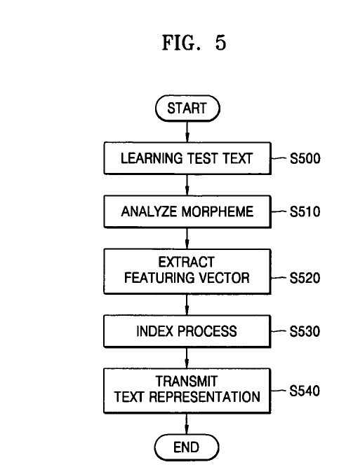

Next, a text classification is performed on the incoming or outgoing P2P traffic based on a learning model (S250). The text classification is in connection with a method of automatically allocating the text into a category predetermined by automatic text categorization. The automatic text categorization allows a large amount of texts to be efficiently managed and retrieved. In addition, a vast amount of manual jobs can be reduced. For example, the text classification can be divided into 1st to 5th levels. Moreover, the text classification can be divided into 1st to 5th levels in terms of items (e.g., pornography, violence, language). The text classification will be described in more detail with reference to FIG. 5.

Next, it is determined whether the P2P traffic in transmission is harmful (S260). Whether the P2P traffic is harmful is determined through a learning result. For example, in case that the text is 4th level or 5th level, it can be determined that the P2P traffic is harmful. When it is determined that the P2P traffic is not harmful, the P2P traffic is passed (S275). Otherwise, when it is determined that the P2P traffic is harmful, the P2P traffic is blocked (S270).

Since, in the P2P harmful information blocking, the input text is a text having a length of about 10 to 128 bytes rather than the typical long text, every word resulting from the morphological analysis can be used in a level classification without a need to extract the search word. Here, the determination on the text harmfulness based on the learning will not be advantageous until an amount of a target text reaches a certain level.

Among the algorithms shown in FIGS. 1 and 2, assume that a dictionary-based algorithm shown in FIG. 1 is employed first. In case that the text is determined to be “obviously harmful” or “obviously harmless,” the result will be reflected as it is. Here, the term “obviously harmful” refers to a case where the traffic includes an obviously harmful word having a very high weight defined in the dictionary. In addition, the term “obviously harmless” refers to a case where the traffic does not have any harmful word defined in the dictionary. In case that the text is determined to be neither “obviously harmful” nor “obviously harmless,” the learning-based algorithm shown in FIG. 2 is employed. The learning-based algorithm uses the learning data to make determination for a case where it is difficult to determine the text to be “obviously harmful” or “obviously harmless.” Therefore, the learning-based algorithm shows a higher accuracy than the dictionary-based algorithm in this case. In other words, the dictionary-based algorithm of FIG. 1 is an algorithm having a faster performance, while the learning-based algorithm of FIG. 2 is an algorithm having a higher accuracy.

To improve the performance of the dictionary-based algorithm of FIG. 1 and the learning-based algorithm of FIG. 2, a compound noun processing and clerical error correction can be performed in the operation of analyzing morphemes, which is common to the two algorithms. Through this, the input text can be separated into the parts of speech defined in the harmful-word dictionary. In addition, the detection performance can be improved.

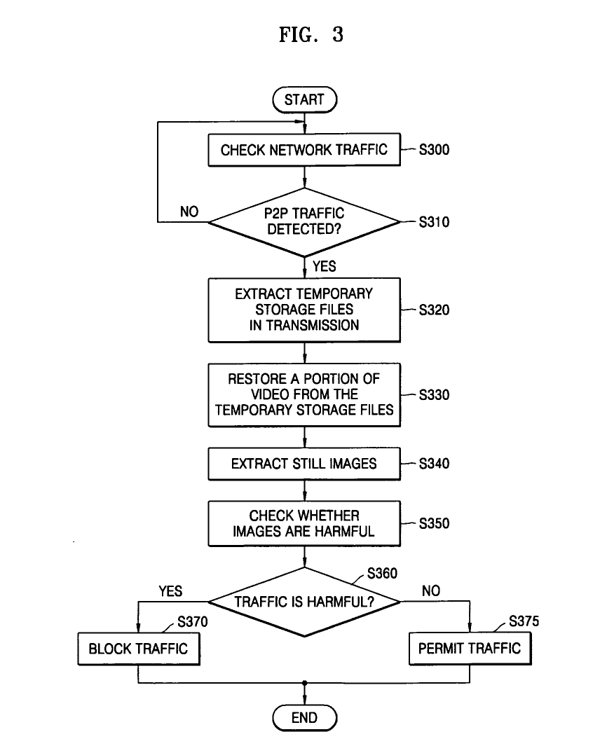

FIG. 3 is a flow chart for explaining a process of selectively blocking harmful P2P traffic by using video classification algorithm according to an embodiment of the present invention.

Assuming that, though there may be a slight difference according to an operational mode of the P2P program, a widely used moving key program is employed, an video file is transmitted in pieces rather than it is played back in real time on the P2P network. Therefore, only after the entire video file is totally reconfigured, the user can play the video file. Accordingly, in the video classification algorithm of the P2P network, it is necessary to determine the video harmfulness by using the extracted still images from the video file, rather than determine it in real time.

Referring to FIG. 3, network traffic is monitored in a P2P traffic selective blocking system on a network (S300).

Next, it is determined whether the P2P traffic is detected (S310). This determination will be described later in more detail with reference to FIG. 6. When it is determined that the P2P traffic is not detected, the process proceeds to operation S300. Otherwise, when it is determined that the P2P traffic is detected, the process proceeds to operation S320.

Next, a temporary storage file in which the file in transmission is temporarily stored is extracted (S320).

Next, a portion of the video is restored from the extracted temporary storage file (S330).

Next, still images are extracted from the restored portion of the video (S340). However, there remains a problem regarding a range of the video file used to extract still images. For example, a movie having a playing time of 2 hours may provoke argument only due to the pornographic contents of 3 minutes. However, in this specification, only the generally acknowledged pornography, i.e., the pornography that can be determined harmful based on any portion of still images extracted from the entire video is considered.

As a method of extracting still images, there are two methods such as a key frame extraction method and a designated time extraction method. The key frame extraction method has a merit in that the repetitive extraction of the identical frame can be prevented. However, it has a drawback in that the execution time is long. On the contrary, the designated time extraction method has a merit in that the execution time is short, but has a drawback in that the substantially identical scenes can be repeatedly extracted. By using at least one of the two methods (preferably, depending on the method adapted to the products), the still images are extracted from the video file.

Next, based on the extracted still images, it is determined whether the images are harmful by using a harmful image checking engine (S350).

Next, it is determined whether the P2P traffic in transmission is harmful (S360). This determination is based on whether the harmful image is detected among the received images. When it is determined in operation S360 that the P2P traffic is not harmful, the P2P traffic is passed (S375). Otherwise, when it is determined that the P2P traffic is harmful, the P2P traffic is blocked (S370).

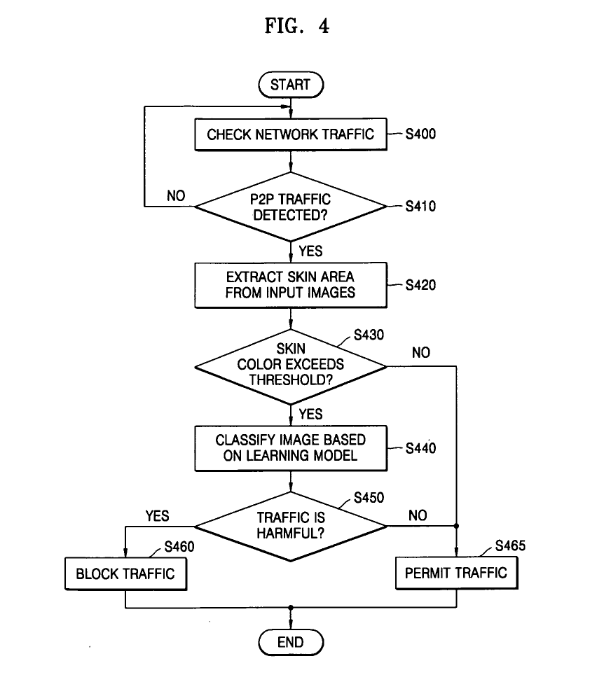

FIG. 4 is a flow chart for explaining a process of selectively blocking harmful P2P traffic by using image classification algorithm according to another embodiment of the present invention.

Network traffic is monitored in a P2P traffic selective blocking system on a network (S400).

Next, it is determined whether the P2P traffic is detected (S410). This determination will be described later in more detail with reference to FIG. 6. When it is determined that the P2P traffic is not detected, the process proceeds to operation S400. Otherwise, when it is determined that the P2P traffic is detected, the process proceeds to operation S420.

Next, a skin area is extracted from the P2P input image (S420). Here, the P2P input image may be an image file of the P2P traffic. In addition, the P2P input image may also be the still images extracted by the video classification algorithm, as illustrated in FIG. 3.

Next, it is determined whether a skin color occupying the extracted skin area exceeds a threshold (S430). In case that a portion of the skin color does not exceed the threshold, the process proceeds to operation S465. Otherwise, in case that the skin color exceeds the threshold, the process proceeds to operation S440.

Next, in operation S440, the image classification is performed based on a learning model. To perform the image classification based on the learning model, image featuring vectors are generated. Here, the image featuring vectors are used as an SVM identifier. The image featuring vectors used as input vectors of the SVM identifier are compared with the SVM learning model to perform the image classification. The images herein can be classified in the manner described in FIG. 3.

Next, it is determined whether the traffic is harmful (S450). This determination is based on whether the received images are classified into the harmful images. When it is determined that the traffic is not harmful, the P2P traffic is passed (S465). Otherwise, when it is determined that the traffic is harmful, the P2P traffic is blocked (S460).

The P2P input image of FIG. 4 may be image files of the P2P traffic. In addition, the P2P input image may also be the still images extracted by the video classification algorithm as illustrated in FIG. 3.

FIG. 5 is a detailed flow chart for explaining operation S250 of FIG. 2.

First, a learning test texts are collected (S500).

Next, morphological analysis is made on the learning test texts collected in operation S500 such that the learning test text is converted to enable mechanical processing and parts of speech reflecting the feature or contents of the text are extracted (S510). A morphological analyzer is used to extract the parts of speech. With this, a sentence is divided into respective morphemes so that the parts of speech are determined. In Korean, there are a lot of verbs provided by attaching a verb derivate suffix to a verbal type noun, so that the ratio of the noun is large. Here, among the extracted content words, there are stop words which do not have meaningful information due to common usage in various texts. To process the stop words, a stop-word dictionary is defined and terms corresponding to the stop words are removed at the time of extracting the parts of speech.

Next, among the parts of speech extracted by the morphological analysis, only the parts of speech useful in categorization learning are extracted as featuring vectors (S520). In other words, in the operation of extracting the featuring vectors, the parts of speech useful in categorized classification are selected among the parts of speech in the text. The number of the parts of speech in the learning text is ranged from several ten thousands to several hundred thousands. Therefore, if all content words are selected, it will take a long time for classification. Accordingly, to reduce the number of featuring vectors without degrading the performance of the text categorization, the amount of the parts of speech in the learning text is calculated and only the parts of speech having a large amount of information are selected as the featuring vectors.

Next, index operation on how to display the text among the extracted parts of speech extracted by the featuring vector is performed (S530). Here, the term “index” refers to how to represent the text with the selected featuring vectors. Since the text representation gives a significant impact on overall generalization performance of the text categorization system, each text is represented in a type appropriate to learning. Assuming that the order of the words in the text does not incur a significant problem in using the featuring vector extracted in the operation of extracting featuring vectors as an index words, the text is represented in a type of bag-of-words rather than an object represented by a sequence. The text representation method typically used is a vector space model. The vector space model represents a text as one vector using a term frequency (TF) of each featuring vector of the entire text. In general, the vector space model represent texts by weighting the TF, an inverse document frequency (IDF), or an inverse category frequency (ICF) of the featuring vectors.

Next, the text representation provided in operation S530 is transmitted such that the text classification can be performed in the learning model in operation S250 of FIG. 2 (S540).

FIG. 6 is a detailed flow chart for explaining a process of detecting the harmful P2P traffic of FIGS. 1 to 4.

IP ports are checked and it is determined whether IP ports are port numbers of the frequently used program (S600). The IP port checking refers to checking of the IP port number of the frequently used network program, other than the P2P program, on the personal computer. When it is determined that the checked port is identified as the IP port number of the frequently used program other than the P2P program, the process proceeds to operation S650. Further, when it is determined that the checked port is not identified as the IP port number of the frequently used program other than the P2P program, the process proceeds to operation S610.

Next, as web traffic and FTP traffic have predetermined patterns according to the traffic size and characteristics of the featuring protocol of transmitting/receiving peers, the currently used transmitting/receiving IP ports are analyzed by analyzing the P2P protocol and the amount of traffic (S610).

Next, it is determined whether the transmitting/receiving IP ports analyzed in operation S610 are IP ports through which the existing known P2P traffic is transmitted (S620). Here, whether or not the traffic is the existing known P2P traffic is determined by, for example, a method of detecting every IP port number used in the P2P program to match the port number, through which the current traffic is transmitted, such as in the existing firewall device. When the traffic is the existing known P2P traffic, the process proceeds to operation S660. Otherwise, when the traffic is not the existing known P2P traffic, the process proceeds to operation S630.

Next, when it is not the existing known P2P traffic, it is determined whether the transmitting/receiving IP is 1 to N connection (S630). In case that the transmitting/receiving IP is 1 to N connection, the process proceeds to operation S660.

Further, in case that the transmitting/receiving IP is not the 1 to N connection, it is determined whether more than a predetermined size of data are transmitted and received through a port number 80, or a web port (S640).

In case that the predetermined size of data are transmitted and received through the port number 80, or the web port, the process proceeds to operation S660. Otherwise, in case that the predetermined size of data are not transmitted and received through the port number 80, the process proceeds to operation S650.

In operation S650, it is determined that the currently transmitted/received traffic is not the P2P traffic.

In operation S660, it is determined that the currently transmitted/received traffic is the P2P traffic.

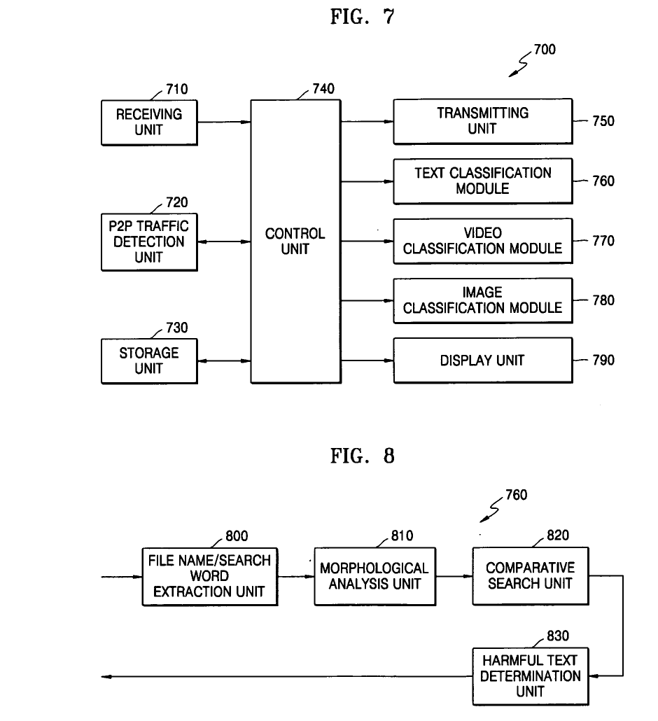

FIG. 7 is a block diagram showing an apparatus of selectively blocking harmful P2P traffic on a network according to an embodiment of the present invention.

The harmful traffic selective blocking device 700 includes a receiving unit 710, a P2P traffic detection unit 720, a storage unit 730, a transmitting unit 750, a text classification module 760, an video classification module 770, an image classification module 780 and a control unit 740 controlling the afore-mentioned units.

The receiving unit 710 rather than the running application program receives the incoming traffic from the external terminals. In case that the traffic is not the P2P traffic, the receiving unit 710 transmits the traffic to the original receiving application program.

The P2P traffic detection unit 720 determines whether the traffic input through the receiving unit 710 is the P2P traffic. If so, the P2P traffic detection signal is output to the control unit 740.

The storage unit 730 registers a program controlling the overall operation of the harmful traffic selective blocking device. The control unit 740 processes the program registered in the storage unit 730 to control the operation of the harmful traffic selective blocking device.

The transmitting unit 750 interrupts the traffic transmitted to the external terminals to determine whether the traffic is the P2P traffic. If not, the traffic is transmitted to the original destination. Although the receiving unit 710 and the transmitting unit 750 have been described separately arranged, these two units 710 and 750 can be combined into the transceiver unit.

When the P2P traffic detection signal is input from the P2P traffic detection unit 720, the control unit 740 controls the P2P traffic to be transmitted to the text classification module 760, the video classification model 770 and the image classification model 780. In addition, in case that the currently transmitted P2P traffic is the harmful P2P traffic, the text classification model 760, the video classification model 770, and the image classification model 780 output the harmful P2P traffic determination signal to the control unit 740. When the harmful P2P traffic determination signal is input, the control unit 740 controls the receiving unit 710 and the transmitting unit 750 to block the transmission of the harmful P2P traffic. Here, a term “harmful P2P traffic determination unit” (not shown) refers to a unit including all of the text classification model 760, the video classification model 770 and the image classification model 780. The harmful P2P traffic determination unit determines whether the P2P traffic is harmful or illegal traffic.

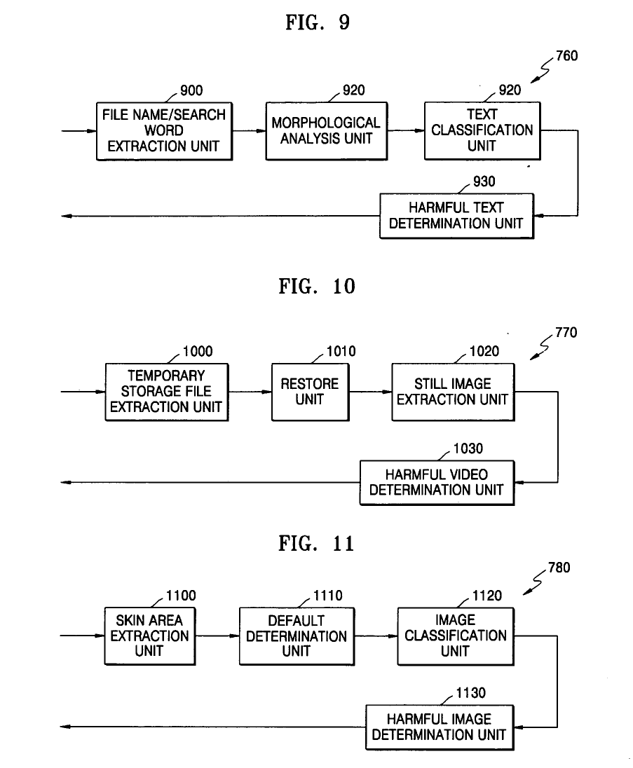

Determining whether the P2P traffic input through the text classification model 760 is harmful or illegal traffic will be described in more detail with reference to FIGS. 8 and 9.

Determining whether the P2P traffic input through the video classification model 770 is harmful or illegal traffic will be described in more detail with reference to FIG. 10.

Determining whether the P2P traffic input through the image classification model 780 is harmful or illegal traffic will be described in more detail with reference to FIG. 11.

The display unit 790 is a display device, such as a liquid crystal display (LCD), informing a user of the data input through the receiving unit 710 and the data input by the control of the control unit 740. Accordingly, in case that the currently input traffic is the harmful P2P traffic, the display unit 790 informs the user that the currently input traffic is the harmful P2P traffic.

FIG. 8 is an example of the detailed block diagram showing the text classification module 760 of FIG. 7.

The text classification module 760 includes a file name/search word extraction unit 800, a morphological analysis unit 810, a comparative search unit 820 and a harmful text determination unit 830.

The file name/search word extraction unit 800 extracts the file name of the incoming P2P traffic in case that the P2P traffic is incoming, and the search word of the outgoing P2P traffic in case that the P2P traffic is outgoing.

The morphological analysis unit 810 performs the morphological analysis on the file name or the search word extracted by the file name/search word extraction unit 800. From this, the parts of speech such as nouns, verbs, and adjectives are extracted from the file name and the search word.

The comparative search unit 820 compares the extracted parts of speech, such as nouns, verbs, and adjectives with harmful words in a harmful-word dictionary. Here, the term “harmful-word dictionary” refers not to a dictionary used for the typical harmful text classification, but to a dictionary having weights based on the features of the terms frequently used in the P2P network. The harmful-word dictionary may load and use words already stored in the storage unit 730. Alternatively, the harmful-word dictionary may be stored in the storage unit (not shown) provided in the text classification module 760. The comparative search unit 820 outputs to the harmful text determination unit 830 the comparative searching signal compared and searched by the part of speech among the parts of speech detected by comparing with the harmful-word dictionary.

In case that the harmful words in the comparative search signals exceeds a predetermined range, the harmful text determination unit 830 determines that the currently incoming traffic is the harmful text traffic based on the comparative searching signal input from the comparative searching unit 820.

When the traffic is determined to be the harmful text traffic, the harmful text determination unit 830 transmits the harmful text determination signal (harmful P2P traffic determination signal) to the control unit 740.

When the harmful text determination signal is input from the text classification model 760, the control unit 740 blocks the input traffic.

FIG. 9 is another example of the detailed block diagram showing a text classification module 760 of FIG. 7.

The text classification module 760 includes a file name/search word extraction unit 900, a morphological analysis unit 910, a text classification unit 920, and a harmful text determination unit 930.

The file name/search word extraction unit 900 extracts the file name of the incoming P2P traffic in case that the P2P traffic is incoming, and the search word of the outgoing P2P traffic in case that the P2P traffic is outgoing.

The morphological analysis unit 910 performs the morphological analysis on the file name or the search word extracted by the file name/search word extraction unit 900. From this, the parts of speech such as nouns, verbs, and adjectives are extracted from the file name and the search word.

The text classification unit 920 classifies the text based on the learning model by extracting featuring vectors from the extracted parts of speech such as nouns, verbs, adjectives to compare the featuring vector with the already performed learning result. The text classification unit 920 outputs to the harmful text determination unit 930 the text classification signal generated by the text classification based on the learning model.

In case that the traffic falls into a predetermined text category, the harmful text determination unit 930 determines that the currently incoming traffic is the harmful text traffic, based on the text classification signal input from the text classification 920. When it is determined that the traffic is the harmful text traffic, the harmful text determination unit 930 transmits the harmful text determination signal (harmful P2P traffic determination signal) to the control unit 740.

When the harmful text determination signal is input from the text classification model 760, the control unit blocks the traffic input through the receiving unit 710.

FIG. 10 is a detailed block diagram showing an video classification module 770 of FIG. 7.

The video classification module 770 includes a temporary storage file extraction unit 1000, a restoring unit 1010, a still image extraction unit 1020, and a harmful video determination unit 1030.

The temporary storage file extraction unit 1000 extracts the temporary storage file in which the traffic input through the receiving unit 710 is temporarily stored.

The restoring unit 1010 restores a portion of the video from the extracted temporary storage file.

The still image extraction unit 1020 extracts still images from the portion of the restored video. However, there still remains a problem regarding a range of the video file used to extract still images. For example, a movie having a playing time of 2 hours may provoke argument only due to the pornographic contents of 3 minutes. However, in this specification, only the generally acknowledged pornography, i.e., the pornography that can be determined harmful based on any portion of the still images extracted from the entire video is considered.

As a method of extracting still images, there are two methods such as a key frame extraction method and a designated time extraction method. The key frame extraction method has a merit in that repetitive extraction of identical frames can be prevented. However, it has a drawback in that the execution time is long. On the contrary, the designated time extraction method has a merit in that the execution time is short, but has a drawback in that the substantially identical scenes can be repeatedly extracted. By using at least one of the two methods (preferably, depending on the method adapted to the products), the still images are extracted from the video file.

The harmful video determination unit 1030 performs the harmful image checking based on the extracted still images using a harmful image checking engine. When it is determined that the image is harmful, the harmful video determination unit 1030 transmits the harmful video determination signal (harmful P2P traffic determination signal) to the control unit 740.

When the harmful video determination signal is input from the video classification model 770, the control unit 740 blocks the traffic input through the receiving unit 710.

FIG. 11 is a detailed block diagram showing an image classification module 780 of FIG. 7.

The image classification module 780 includes a skin area extraction unit 1100, a default determination unit 1110, an image classification unit 1120, and a harmful image determination unit 1130.

The skin area extraction unit 1100 extracts the skin area from the image file among the P2P traffic input from the receiving unit 710 or the still images transmitted from the harmful video determination unit, under the control of the control unit 740.

The default determination unit 1110 determines whether a skin color occupying the skin area extracted by the skin area extraction unit 1100 exceeds a predetermined threshold.

In case that the skin color exceeds the predetermined threshold, the image classification unit 1120 extracts a featuring vector containing shape information and skin color information from the default determination unit 1110 to compare with an SVM learning model by using the extracted featuring vector as an SVM identifier. The image classification unit 1120 outputs the image classification signal classified by the SVM learning model to the harmful image determination unit 1130.

When the traffic falls into a predetermined image category, the harmful image determination unit 1130 determines that the currently incoming traffic is the harmful image traffic based on the image classification signal input from the image classification unit 1120. When it is determined that the traffic is the harmful image traffic, the harmful image determination unit 1130 transmits the harmful image determination signal to the control unit 740.

When the harmful image determination signal is input from the image classification model 780, the control unit 740 blocks the traffic input from the receiving unit 710.

As described above, the P2P input image shown in FIG. 11 may be image files of the P2P traffics. In addition, the P2P input image may also be the still images extracted by the video classification algorithm, as described in FIG. 10.

The present invention can also be implemented as a computer-readable medium having embodied thereon computer-executable codes. The computer-readable medium includes any type of recording medium in which computer-readable data can be stored. For example, the computer readable medium includes ROMs, RAMs, CD-ROMs, magnetic tapes, floppy disks, and optical data storages, and other medium implemented as a carrier wave (e.g., transmission via Internet). In addition, the computer readable medium can be distributed in computer systems connected on a network, and stored and executed as computer-executable codes in a distributed manner.

As described above, according to a method and apparatus of selectively blocking harmful P2P traffic on a network, a system is configured such that text contents, image contents, and video contents are detected in a P2P network through a content-based detection technology. In addition, the contents of information transmitted through the P2P network are identified so that the obviously harmful information (e.g., pornography) can be blocked. The contents-based traffic selective blocking system of the present invention can be used in blocking the pornography and illegal software distribution as well as illegal advertisement and pornographic message circulation.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of selectively blocking harmful P2P traffic on a network, the method comprising:
(a) determining whether data transmitted to and from external terminals through the network is P2P traffic;
(b) when it is determined that the data is P2P traffic, determining whether the transmitted and received P2P traffic is harmful;
(c) when it is determined that the traffic is harmful, blocking the P2P traffic transmitted to and from the external terminals.

2. The method according to claim 1, where (a) comprises:
(a-1) checking frequently used IP ports of a network program on a personal computer;
(a-2) analyzing a P2P protocol and traffic amount to analyze a currently activated transmitting/receiving IP port;
(a-3) determining whether the transmitting/receiving IP port analyzed in (a-2) is a previously defined P2P traffic port;
(a-4) when it is determined that the transmitting/receiving IP port is not the previously defined IP port, determining whether the transmitting/receiving IP port is 1 to N connection with the external terminals; and
(a-5) when the transmitting/receiving IP port is the previously defined IP port in (a-3), and the transmitting/receiving IP port is 1 to N connection with the external terminal in (a-4), determining that the transmitted and received data is the P2P traffic.

3. The method according to claim 2, wherein, from the determination in (a-4), in a case where more than a predetermined size of data are transmitted and received through a web port even when the transmitting/receiving IP port is not 1 to N connection with the external terminals, performing (a-5).

4. The method according to claim 2, wherein, in (a-3), the determination is made by matching all of IP ports used in the P2P program and the currently used transmitting/receiving IP port numbers.

5. The method according to claim 1, wherein (b) comprises:
(b-1) when data transmitted to and from the external terminals are text data, determining whether the text data is incoming traffic or outgoing traffic;
(b-2) in case that text data are the incoming traffic in (b-1), extracting a file name, and in case the text data are the outgoing traffic in (b-1), extracting a search word;
(b-3) performing morphological analysis on the extracted file name or search word;
(b-4) comparing the analyzed morphemes with harmful words in a harmful-word dictionary; and
(b-5) determining whether the analyzed morphemes are harmful based on the comparison in (b-4).

6. The method according to claim 1, wherein (b) comprises:
(b-1) when data transmitted to and from the external terminals are text data, determining whether the text data is incoming traffic or outgoing traffic;
(b-2) in case that text data are the incoming traffic in (b-1), extracting a file name, and in case the text data are the outgoing traffic in (b-1), extracting a search word;
(b-3) performing morphological analysis on the extracted file name or search word;
(b-4) comparing the analyzed morphemes with a learning model to classify texts; and
(b-5) when the classified texts falls into a predetermined criterion, performing whether the classified texts are harmful.

7. The method according to claim 1, wherein (b) comprises:
(b-1) when data transmitted to and from the external terminals are video files, extracting a temporary storage file;
(b-2) restoring a portion of video from the temporary storage file extracted in (b-1);
(b-3) extracting still images from the restored portion of video; and
(b-4) when the still images fall into a predetermined criterion, performing whether the still images are harmful.

8. The method according to claim 1, wherein (b) comprises:
(b-1) when data transmitted to and from the external terminals are image files, extracting a skin area form the image files;
(b-2) determining whether a portion of a skin color occupying the extracted skin area exceeds a threshold;
(b-3) when it is determined that the portion of the skin color occupying the extracted skin area exceeds the threshold, comparing the extracted skin area with a learning model; and
(b-4) when the comparison result falls into a predetermined criterion, determining whether the skin area is harmful.

9. An apparatus of selectively blocking harmful P2P traffic on a network comprising:
a transceiver unit transmitting and receiving data with external terminals;
a P2P traffic detection unit determining whether data transmitted to and from the external terminals are P2P data;
a harmful P2P traffic determination unit determining whether the data transmitted to and from the external terminals are harmful; and
a control unit sending data transmitted and received through the transceiver unit to the harmful P2P traffic determination unit when a P2P traffic detection signal is input from the P2P traffic detection unit, and controlling the transceiver to block transmitting and receiving data with the external terminals when a harmful P2P traffic determination signal is input from the harmful P2P traffic determination unit.

10. The apparatus according to claim 9, wherein the harmful P2P traffic determination unit comprises at least one of:
a text classification module determining whether character data transmitted to and from the external terminals are harmful;
an video classification module determining whether video data transmitted to and from the external terminals are harmful; and
an image classification module determining whether image data transmitted to and from the external terminals are harmful.

11. The apparatus according to claim 10, wherein the text classification module comprises:
a file name and search word extraction unit extracting a file name of incoming P2P traffic when the P2P traffic from the transceiver is incoming, and a search word of outgoing P2P traffic when the P2P traffic from transceiver is outgoing;
a morphological analysis unit performing morphological analysis on the extracted file name or search word to extract a part of speech;
a comparative search unit comparing the extracted part of speech with a already-stored harmful-word dictionary to generate a comparative search signal; and
a harmful text determination unit receiving the comparative search signal to output a harmful text determination signal to the control unit when it is determined that the harmful words of the harmful-word dictionary exist in the extracted parts of speech.

12. The apparatus according to claim 10, wherein the text classification module comprises:
a file name and search word extraction unit extracting a file name of incoming P2P traffic when the P2P traffic from the transceiver is incoming, and a search word of outgoing P2P traffic when the P2P traffic from transceiver is outgoing;
a morphological analysis unit performing morphological analysis on the extracted file name or search word to extract a part of speech;
a text classification unit performing a text classification using learning model on the extracted part of speech to generate a text classification signal; and
a harmful text determination unit outputting a harmful text determination signal to the control unit when it is determined that the text falls into a predetermined criterion based on the text classification signal.

13. The apparatus according to claim 10, wherein the video classification module comprises:
a temporary storage file extraction unit extracting a temporary storage file on which P2P traffic input from the transceiver is temporarily stored;
a restoring unit restoring a portion of an video of a temporary storage file extracted from the temporary storage file extraction unit;
a still image extraction unit extracting still images for a portion of video restored by the restoration unit; and
a harmful video determination unit outputting a harmful video determination signal to the control unit when it is determined that the video falls into a predetermined criterion through the still image extracted from the still image extraction unit.

14. The apparatus according to claim 13, wherein the still image extraction unit extracts still images in a key frame unit.

15. The apparatus according to claim 13, wherein the still image extraction unit extracts still images in a designated time interval.

16. The apparatus according to claim 10, wherein the image classification module comprises:
a skin area extraction unit extracting a skin area of P2P traffic input from the transceiver;
a criterion determination unit determining whether a skin color occupying the skin area extracted through the skin area extraction unit exceeds a threshold;
an image classification unit classifying images based on the skin color and shape information to generate an image classification signal when the skin color occupying the criterion determination unit exceeds the threshold; and
a harmful image determination unit outputting a harmful image determination signal to the control unit when it is determined that the image falls into a predetermined criterion based on the image classification signal.

17. A computer-readable medium having embodied thereon a computer executable program for the method according to claim 1.
